(19) United States
(12) Patent Application Publication
(10) Pub. No.: US 2026/0187378 A1
(43) Pub. Date: Jul. 2, 2026

(54) CONTEXTUAL ALT TEXT GENERATION FOR WEB IMAGES

(71) Applicant: Oracle International Corporation, Redwood Shoresc, CA (US)

(72) Inventors: Sourabh Singh Yadav, Bengaluru (IN); Sandeep Jana, Bengaluru (IN); Kulbhushan Pachauri, Bangalore (IN)

(73) Assignee: Oracle International Corporation, Redwood Shores, CA (US)

(21) Appl. No.: 19/195,410

(22) Filed: Apr. 30, 2025

(30) Foreign Application Priority Data
Dec. 27, 2024 (IN) 202441103630

(51) Int. Cl. G06F 40/40; G06F 40/205; G06F 40/295; G06V 30/413; G06V 30/42; G06V 40/16; G06V 40/20; G10L 13/02

(52) U.S. Cl. CPC G06F 40/40; G06F 40/205; G06F 40/295; G06V 30/413; G06V 30/42; G06V 40/161; G06V 40/175; G06V 40/20; G10L 13/02

(57) ABSTRACT

Systems, methods, and computer-readable media may provide for contextual alt text generation for web images. A webpage may be parsed to extract images and text. The images may be analyzed to detect representations of persons. Face localization may be performed to detect faces in the representations of the persons. A face embedding for each detected face may be generated to create a set of face embeddings. The text extracted may be analyzed to detect named entities. A name embedding for each detected named entity may be generated to create a set of name embeddings. Bipartite matching may be used to correlate at least part of the set of face embeddings with at least part of the set of name embeddings to create a set of correlation results. Contextualized alt text may be caused to be generated based on the set of correlation results from the bipartite matching.

### CROSS REFERENCE TO RELATED APPLICATION

This application claims the benefit of, and priority to India Provisional Application No. 202441103630, filed on Dec. 27, 2024, which is hereby incorporated by reference in its entirety for all purposes.

### TECHNICAL FIELD

This disclosure generally relates to artificial intelligence (AI) services and particularly to systems, methods, and computer-readable media for contextual alt text generation for web images.

### BACKGROUND

Images are integral to making webpages visually appealing and engaging. For instance, news articles often include images of relevant people, celebrities post pictures on social media, and websites use images to make their content more eye-catching. While these visuals enhance the web experience for many users, they pose significant challenges for individuals with vision impairments, including blindness, low vision, color blindness, and cognitive challenges such as dyslexia and ADHD.

To address these accessibility issues, webpage owners use alternative text (alt text). Alt text is used to describe an image for users who cannot see it, such as those using screen readers, improving accessibility and enhancing the user experience. It also aids in search engine optimization (SEO) by providing context to search engines, potentially boosting website visibility.

Alt text is important for several reasons, including the following. Access for customers with disabilities may be improved. Businesses must adhere to Web Content Accessibility Guidelines to avoid legal issues related to accessibility. Search engine optimization (SEO) for websites may be enhanced.

However, conventional approaches for generating alt text often fall short. The conventional solutions frequently produce vague or irrelevant descriptions, especially when identifying people or conveying the image's context. This inadequacy can significantly detract from the overall user experience, making it difficult for individuals with disabilities to fully engage with the content. Moreover, well-crafted alt text is not only beneficial for users with disabilities but also for sighted users who might be unfamiliar with the people or context depicted in the images.

Thus, there is a need to solve these problems and provide for contextual alt text generation for web images. These and other needs are addressed by the present disclosure.

### BRIEF SUMMARY

Certain embodiments of the present disclosure relate generally to artificial intelligence (AI) services and particularly to systems, methods, and computer-readable media for contextual alt text generation for web images.

In one aspect, a system may facilitate contextualized alt text generation for web images. The system may include one or more processing devices and memory communicatively coupled with and readable by the one or more processing devices and having stored therein processor-readable instructions which, when executed by the one or more processing devices, cause the system to perform one or a combination of the following operations. A webpage may be parsed to extract one or more images and text from the webpage. The webpage may be rendered with an endpoint device. The one or more images from the webpage may be analyzed to detect one or more representations of one or more persons in the one or more images. Face localization may be performed to detect one or more faces in the one or more representations of the one or more persons. A face embedding for each detected face of the detected one or more faces may be generated to create a set of one or more face embeddings. The text extracted from the webpage may be analyzed to detect one or more named entities in the text. A name embedding for each detected named entity of the detected one or more named entities may be generated to create a set of one or more name embeddings. Bipartite matching may be used to correlate at least part of the set of one or more face embeddings with at least part of the set of one or more name embeddings to create a set of correlation results. Contextualized alt text may be caused to be generated based at least in part on the set of correlation results from the bipartite matching. The contextualized alt text may be transmitted to the endpoint device to facilitate audible presentation of the contextualized alt text with assistive technology software.

In another aspect, a method may facilitate contextualized alt text generation for web images. The method may include one or a combination of the following. A webpage may be parsed to extract one or more images and text from the webpage. The webpage may be rendered with an endpoint device. The one or more images from the webpage may be analyzed to detect one or more representations of one or more persons in the one or more images. Face localization may be performed to detect one or more faces in the one or more representations of the one or more persons. A face embedding for each detected face of the detected one or more faces may be generated to create a set of one or more face embeddings. The text extracted from the webpage may be analyzed to detect one or more named entities in the text. A name embedding for each detected named entity of the detected one or more named entities may be generated to create a set of one or more name embeddings. Bipartite matching may be used to correlate at least part of the set of one or more face embeddings with at least part of the set of one or more name embeddings to create a set of correlation results. Contextualized alt text may be caused to be generated based at least in part on the set of correlation results from the bipartite matching. The contextualized alt text may be transmitted to the endpoint device to facilitate audible presentation of the contextualized alt text with assistive technology software.

In yet another aspect, one or more non-transitory, machine-readable media may have machine-readable instructions thereon which, when executed by one or more processing devices, cause the one or more processing devices to perform one or a combination of the following operations. A webpage may be parsed to extract one or more images and text from the webpage. The webpage may be rendered with an endpoint device. The one or more images from the webpage may be analyzed to detect one or more representations of one or more persons in the one or more images. Face localization may be performed to detect one or more faces in the one or more representations of the one or more persons. A face embedding for each detected face of the detected one or more faces may be generated to create a set of one or more face embeddings. The text extracted from the webpage may be analyzed to detect one or more named entities in the text. A name embedding for each detected named entity of the detected one or more named entities may be generated to create a set of one or more name embeddings. Bipartite matching may be used to correlate at least part of the set of one or more face embeddings with at least part of the set of one or more name embeddings to create a set of correlation results. Contextualized alt text may be caused to be generated based at least in part on the set of correlation results from the bipartite matching. The contextualized alt text may be transmitted to the endpoint device to facilitate audible presentation of the contextualized alt text with assistive technology software.

In various embodiments, a web browser plugin or web extension of a browser of the endpoint device may facilitate the parsing of the webpage to extract the one or more images and the text from the webpage. In various embodiments, the text extracted from the webpage may be analyzed to recognize context. A context description for the webpage may be generated based at least in part on the analyzing. The generation of the contextualized alt text may be based at least in part on the context description.

In various embodiments, the one or more images from the webpage may be analyzed to recognize one or more facial expressions in the one or more faces in the one or more representations of the one or more persons. The generation of the contextualized alt text may be based at least in part on the recognized one or more facial expressions. In various embodiments, the one or more images from the webpage may be analyzed to recognize one or more actions and/or one or more objects represented in the one or more images. The generation of the contextualized alt text may be based at least in part on the recognized one or more actions and/or the recognized one or more objects.

In various embodiments, the bipartite matching may use face embeddings and name embeddings previously stored in cloud data storage to correlate the at least part of the set of one or more face embeddings with the at least part of the set of one or more name embeddings to create a set of correlation results. In various embodiments, the cloud data storage may be private and personalized to a user of the endpoint device based at least in part on a browsing history of the user. In various embodiments, the contextualized alt text may be used to re-rank the face embeddings and the name embeddings previously stored in the cloud data storage based at least in part on updating one or more weight values of one or more bipartite edge weights between the face embeddings and the name embeddings.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates a block diagram for a framework for contextual alt text generation for web images, in accordance with embodiments according to the present disclosure.

FIG. 2 illustrates one example method for contextual alt text generation for web images, in accordance with embodiments of the present disclosure.

FIG. 3 illustrates a technical block diagram of the framework, in accordance with embodiments according to the present disclosure.

FIG. 4 illustrates online bipartite graph matching, in accordance with embodiments according to the present disclosure.

FIG. 5 is a block diagram illustrating one pattern for implementing a cloud infrastructure as a service system, according to at least one embodiment.

FIG. 6 is a block diagram illustrating another pattern for implementing a cloud infrastructure as a service system, according to at least one embodiment.

FIG. 7 is a block diagram illustrating another pattern for implementing a cloud infrastructure as a service system, according to at least one embodiment.

FIG. 8 is a block diagram illustrating another pattern for implementing a cloud infrastructure as a service system, according to at least one embodiment.

FIG. 9 is a block diagram illustrating an example computer system, according to at least one embodiment.

### DETAILED DESCRIPTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment of the disclosure. It should be understood that various changes may be made in the function and arrangement of elements without departing from the spirit and scope of the disclosure as set forth in the appended claims.

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “example” or “exemplary” is used herein to mean “serving as an example, instance, or illustration.” Any embodiment or design described herein as “exemplary” or “example” is not necessarily to be construed as preferred or advantageous over other embodiments or designs.

In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

Various embodiments may facilitate a unique, adaptive AI solution platform configured for a broad range of users, including non-experts, boosting overall AI service adoption. Various embodiments may provide a seamless, user-friendly experience. Various embodiments may provide for advanced AI capabilities and integration services. Various embodiments may provide for scalability and efficiency, optimizing resource utilization and reducing time-to-market for AI projects, enhancing operational efficiency for users.

Various embodiments according to the present disclosure may correspond to systems and methods for creating AI solutions utilizing intelligent agents that automate the orchestration and deployment of AI models, custom application code, and integrated AI services. Various embodiments may leverage advanced machine learning algorithms, hyperparameter optimization, and real-time data analytics to dynamically select and configure AI components based on project-specific requirements and constraints. By providing an intuitive user interface and customizable workflows, a system according to various embodiments may enhance usability for users with varying expertise levels. Various embodiments may ensure seamless integration with Oracle AI services and other third-party platforms via robust APIs, enabling scalable and efficient end-to-end AI solution development, deployment, and performance monitoring within enterprise environments.

AI agents may be used to help automate processes, generate insights, and optimize performance. These agents may transcend traditional voice-based virtual assistants and may act as employees or partners to help achieve goals. Agents may be categorized into different types based on their perceived intelligence and capabilities, which can be judged from its actions. Various embodiments may use hierarchical agents. Hierarchical agents may be structured in a hierarchy, with high-level agents overseeing lower-level agents. These types of agents may excel in coordinating and prioritizing multiple tasks and sub-tasks. A hierarchical AI agent may, for example, utilize text and video as a universal interface, enabling it to learn diverse tasks across various environments. The hierarchical agent may include a high-level policy that generates instructions and demonstrations and a low-level policy that executes tasks. The high-level policy may adapt to various environments and tasks, while the low-level policy may learn through imitation and reinforcement learning. This hierarchical setup may enable the hierarchical agent to combine high-level reasoning and low-level execution effectively.

Various embodiments according to the present disclosure may solve complex AI tasks using large language models (LLMs) as a controller to manage existing AI models. A controller agent (which may also be referenced herein as a service agent and/or a meta-agent) may be configured to oversee the completion of one or more AI tasks requested by the user.

Further, various embodiments according to the present disclosure may provide for contextual alt text generation for web images that solves the problems of conventional approaches for generating alt text, such as producing vague or irrelevant descriptions, especially when identifying people or conveying the image's context. Various embodiments may provide for alt attributes that are accurate and equivalent in representing content and function. Various embodiments may provide for alt attributes that are succinct. Various embodiments may allow for content and function (if any) to be presented as succinctly as possible, without sacrificing accuracy. In some instances, only a few words may be necessary, though, in other instances, a short sentence or two may be appropriate. Various embodiments may provide for alt attributes that are not redundant and that do not provide the same information as text near the image. Various embodiments may provide for alt attributes that do not include phrases like “image of . . . ” or “graphic of . . . ”, etc. This would be redundant since screen readers already announce “graphic” along with the alt text. Although various may recognize instances when the fact that an image is a photograph or illustration, etc. is important content and when it may be useful to include this in alternative text.

Table 1 below illustrates some examples of inadequate alt text for sample
websites juxtaposed with improved alt text for the sample websites.

| | Inadequate Alt text | Contextual Alt Text |
|---|---|---|
| 1. For An Example Web | Image Credit: Kevin | “Post Malone, Taylor Swift, and |
| Screenshot of an Article about | Mazur/Getty Images | Sabrina Carpenter sitting together, |
| MTV Video Music Awards That | for MTV | holding their MTV Video Music |
| Includes an Image of Post | | Awards trophies, smiling and |
| Malone, Taylor Swift, and | | celebrating their wins.” |
| Sabrina Carpenter | | |
| 2. For An Example Web | Neeraj Chopora and | “Neeraj Chopra and Arshad |
| Screenshot of an Article about an | Arshad Nadeem | Nadeem standing together, each |
| Olympic Rivalry That Includes an | | holding their country's flags after |
| Image of Neeraj Chopora and | | the javelin final, symbolizing |
| Arshad Nadeem | | friendship despite competing at |
| | | the Olympic Games.” |

In the above examples, each image caption is vague and is same as the alt text. In general, they need to be different. Alt text is not to be confused with, or equated to, image captions. Image captions are included in a webpage by an author, editor, etc. along with the creation of the webpage. Alt text is generally added after webpage creation by another entity. Image captions are visibly displayed in the webpage for viewing by a sighted person. Alt text is generally not visibly displayed in a webpage but is embedded in the webpage so a screen software or any assistive technology software can read it aloud and present it audibly to a blind or low-vision person. While image captions are meant to be combined with images to provide context to a sighted person, they do not provide context to a blind or low-vision person. Moreover, describing an image is one thing, but describing an image with the context of the article (as disclosed embodiments do) is another. Context may be defined by the content of the article, the environment of the photograph, the actions that the people are doing, the emotional expressions of the people, and/or the like. With embodiments disclosed, improved alt text along with the detected faces provides deeper context of the image and webpage that bridges the gap of captions and images for a blind or low-vision person.

The following are a few more examples of alt text versions that describe the recommended alt text with sample examples of generated inadequate alt text without context versus improved contextual alt text:
1. Sports Event Article: Consider an article about the T20 World Cup winning ceremony featuring Prime Minister Narendra Modi shaking hands with cricketer Virat Kohli.
   Vague Alt Text: “One person shaking hands with another person in a cordial manner.”
   Contextual Alt Text: “Prime Minister Narendra Modi shaking hands with cricketer Virat Kohli during the T20 World Cup winning ceremony.”
2. Local News Article: Suppose you're reading an article about a charity event where a well-known local celebrity is handing out awards. The article includes a photo of the event with the celebrity and two award recipients
   Vague Alt Text: “Photo of people at an event.” or “One person sharing award to other people”
   Contextual Alt Text: “Rajnikant presenting an award to local heroes Sonu and at the charity event.”

Some sources reported that around 95% of webpages fail to follow Web Content Accessibility Guidelines 2 accessibility guidelines, with the most common issue being missing alt text. Some surveys indicate that most webpages have missing, vague, irrelevant, or repetitive alt text, especially for images involving people. In summary, the vague alt text is too general and does not convey the identities of the individuals or the significance of the occasion, while the improved contextual alt text provides a detailed and relevant description that helps the reader understand the context of the image. The problem with current alt text generation is that it often results in vague or irrelevant descriptions, especially when identifying people or conveying the image alt text in the context of the article. This gap affects both users with disabilities and those who would benefit from more informative content.

Conventional solutions have limitations, including the following. Celebrity recognition: Existing celebrity solutions which are trained on a fixed set of identities do not scale well for automatic alt text generation because the dynamic nature of the internet. These solutions require large databases of people, which are impractical as they require significant Personally Identifiable Information (PII) training data. Collecting dynamic identities globally is infeasible. Moreover, knowing face identities alone is insufficient for generating faithful alt text. Knowledge graphs: Entity-aware captioning methods create image sub-graphs and text sub-graphs fused into a multi-modal knowledge base. One major limitation is their reliance on pre-defined knowledge graphs. The graphs generally include only famous celebrities, whereas news articles often feature a much broader set of people, leading to issues with out-of-dictionary individuals. Large multimodal models (LMMs) struggle with face identification: Latest methods using LMMs struggle to handle multimodal entity information effectively, often failing to generate entities (people names) altogether. Simple fine-tuning on the news image caption domain shows some improvement, but the ability to generate accurate entity information remains lacking. Effective entity-aware alignment is required, which is not easily achievable due to the need for extensive human-labelled datasets. This task is both costly and error-prone, and basic fine-tuning does not suffice to address the complex entity recognition and generation challenges posed by diverse news image captioning tasks. Conventional state-of-the-art automatic alt text generation and image description methods fail to address facial details and the article's context. As faces are critical PII, conventional solutions fail to personalize user experiences without violating PII laws.

Additional challenges for automatic alt text generation with faces may include websites that contain various types of images:
Identifying Relevant Faces in the Presence of Multiple People and Faces: When more than one person is in an image, identifying the most relevant individuals and providing alt text for them is crucial, for example, a celebrity with bodyguards or a prime minister awarding a local celebrity.
Unsupervised Face Identification: Developing unsupervised method that can accurately identify individuals and understand contexts without extensive labelled datasets. While ensuring that the model can adapt to new and unseen individuals may be challenging without explicit training data.
People Action, Expression, and Specific Actions: Sometimes people are depicted performing specific actions. For example, Dhoni hitting a six or Modi playing drums in Japanese attire. Identifying the people and their actions may be essential to enrich the content.
Irrelevant Faces in Decorative Images: Faces in decorative images used to beautify the website may be irrelevant to the webpage's context.

Various embodiments disclosed herein may solve the core problem of identifying the people and creating an alt text which describes the people and the context from the webpage. Disclosed embodiments may address the above-mentioned challenges, limitations, and deficiencies by dynamically integrating contextual information and personalizing face identification without relying on public PII datasets. By leveraging user-specific browsing history and probabilistic assignments, disclosed embodiments may generate accurate, descriptive, and personalized alt text, effectively bridging the gaps left by conventional methods.

Embodiments according to the present disclosure may automatically generate alt text for images containing people by identifying individuals in the images and leveraging the context of web article. Disclosed embodiments may learn the identity of the people, in a continuous and personalized manner, using the information derived from the webpages visited by the user. Disclosed embodiments may provide comprehensive accessibility solutions, integrating advanced alt text generation into cloud services, web development tools, and content management systems. Disclosed embodiments may provide for superior accessibility features and AI-driven personalization. Disclosed embodiments may provide for privacy and security, ensuring high data privacy standards by keeping face identities private and using personalized data securely. Disclosed embodiments may orchestrate a dynamic face recognition database and retrieval augmented caption generation using large multimodal modes (LMMs) and provide for contextualized alt text generation service as web-accessibility-as-a-service model.

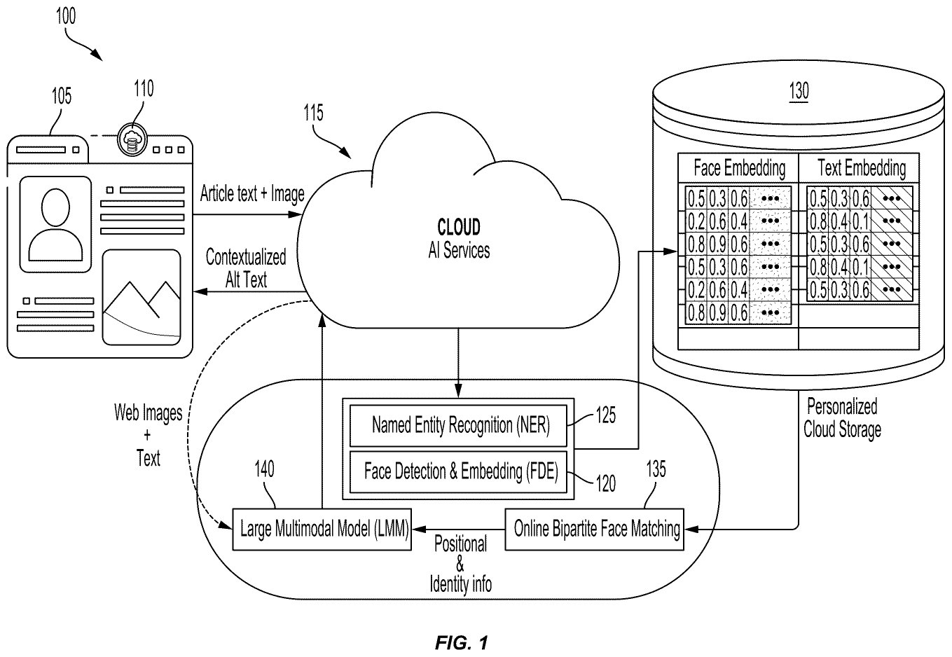

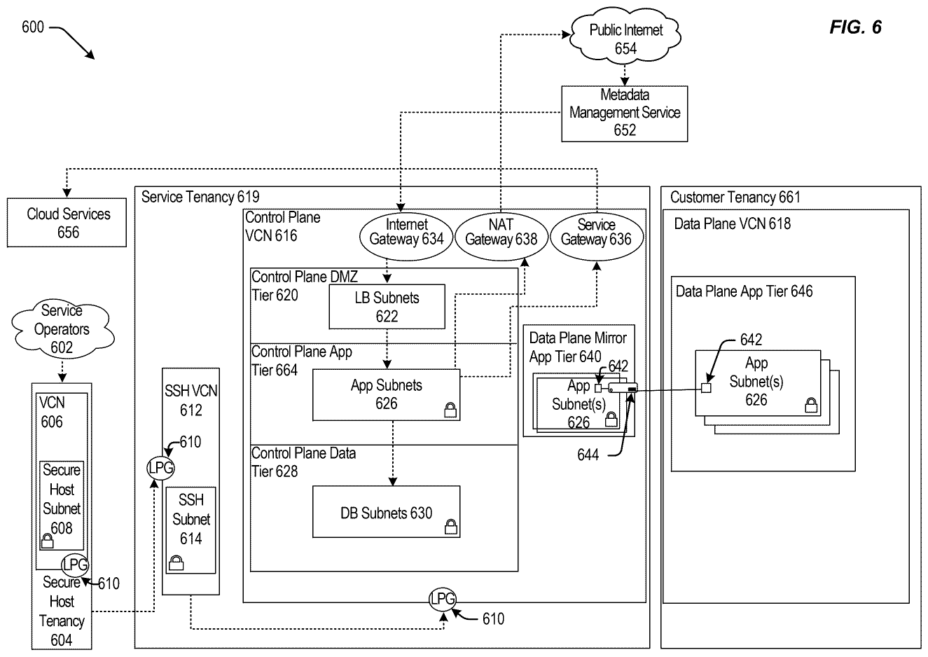

Various embodiments according to the present disclosure may facilitate a unique, adaptive AI solution platform using one or a combination of architectures 600, 700, 800 and/or 900 disclosed herein with respect to FIGS. 6-9. Various embodiments will now be discussed in greater detail with reference to the accompanying figures, beginning with FIG. 1.

FIG. 1 illustrates a block diagram for a framework 100 for contextual alt text generation for web images, in accordance with embodiments according to the present disclosure. The framework 100 may include a webpage 105 rendered on an endpoint device. The webpage 105 may include a title and body text in textual form, as well as one or more images. The framework 100 uses an example of a web browser plugin or web extension 110 (AI extension 110) that may be an extension of cloud AI services provided by a cloud infrastructure 115 that sits on the web browser presenting the webpage 105. The cloud infrastructure 115 and AI services provided by the cloud infrastructure 115 may correspond to components of one or a combination of architectures 600, 700, 800 and/or 900.

The cloud infrastructure 115 may generate contextual alt text for web images based at least in part on the AI extension 110 sending web text and images from the webpage 105 (e.g., which may correspond to a web article). The cloud infrastructure 115 may communicate the contextualized alt text to the endpoint device for the embedding in the webpage 105 so that screen software or any assistive technology software can read it aloud and present it audibly to the user. The browser and/or the AI extension 110 may embed the alt text in the webpage 105.

Additionally or alternatively, disclosed embodiments may enhance search engine optimization (SEO). This may correspond to a contextual alt text service provided by the cloud infrastructure 115 to, for example, website owners so they can augment their websites with the enhanced alt text. Search engines may search for captions of images as well as alt text of images. By linking the enhanced alt text with web images, website owners may increase visibility for their webpages. In some such embodiments, the user may install the AI extension 110 on their webpage in order to provide the web text and images to the cloud infrastructure 115. In other such embodiments, the user may provide the website address to the cloud infrastructure 115, which may then gather the web text and images from the corresponding webpage. Other embodiments are possible.

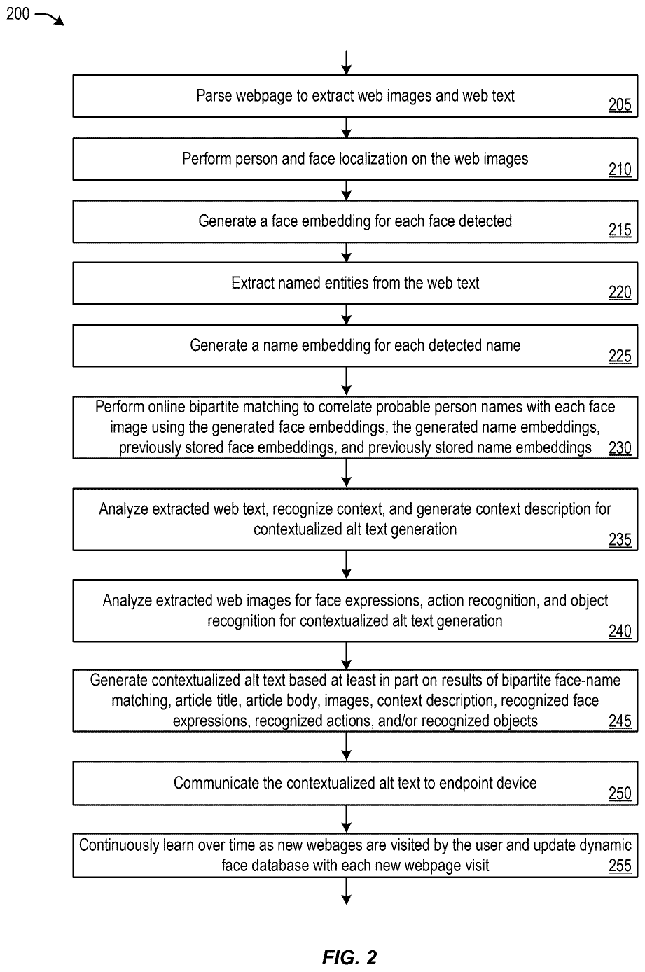

FIG. 2 illustrates one example method 200 for contextual alt text generation for web images, in accordance with embodiments of the present disclosure. One or a combination of the aspects of the method 200 may be performed in conjunction with one or more other aspects disclosed herein, and the method 200 is to be interpreted in view of other features disclosed herein and may be combined with one or more of such features in various embodiments. Teachings of the present disclosure may be implemented in a variety of configurations that may correspond to the configurations disclosed herein. As such, certain aspects of the methods disclosed herein may be omitted, and the order of the steps may be shuffled in any suitable manner and may depend on the implementation chosen. Moreover, while the aspects of the methods disclosed herein, may be separated for the sake of description, it should be understood that certain steps may be performed simultaneously or substantially simultaneously.

As indicated by block 205, the webpage 105 may be parsed to extract relevant information (e.g., web images, article text, headings, etc.). As indicated by block 210, person and face localization may be performed on the web images. This may include the images being analyzed to detect the presence of people and face bounding boxes. As indicated by block 215, for each detected face, a face embedding may be generated. Each face embedding may correspond to a vector (numerical expression) of a face that indicates key features identifying a face (akin to a fingerprint). The face embeddings may be provided as input to online bipartite matching.

As indicated by block 220, named entities may be extracted from the web text. There may exist names of the people in the web text corresponding to the faces in the images. As indicated by block 225, for each detected name, a name embedding may be generated. Each face embedding may correspond to a vector of a named entity that may indicate characteristics of the named entity. The name embeddings may also be provided as input to the online bipartite matching.

As indicated by block 230, online bipartite face matching may be performed to correlate probable person names with each face image using the surrounding context. The online bipartite face matching may use the newly generated face embeddings, the newly generated name embeddings, previously stored face embeddings (if available), and previously stored name embeddings (if available) as inputs. This approach may avoid the need for public PII data and may ensure privacy. The graph-matching technique may use a bipartite graph to map face embedding to the person names. The cloud infrastructure 115 may provide for dynamic face identities with the online bipartite matching. An online bipartite matching algorithm may be employed to continuously update a user-specific face database in the user's personalized cloud storage with embeddings extracted from faces encountered across various webpages. This dynamic database may adapt in real-time, allowing for the seamless identification of recurring and new faces. The face matching process may be based on the continuous updating of probabilities (or edge weights) for face-name pairs, enhancing accuracy as new information becomes available. This online update process may set the disclosed system apart from static face recognition models, providing greater flexibility in dealing with dynamic and evolving web content.

As indicated by block 235, the web text may be analyzed, context of the article may be recognized, and a description of the context may be generated. The description of the context, web text, and/or images may be used for input for contextualized alt text generation. As indicated by block 240, the web images may be analyzed for face expressions, action recognition, and object recognition. The analysis results may also be used for input for contextualized alt text generation.

As indicated by block 245, contextualized alt text may be generated based at least in part the correlation results of the bipartite face-name matching, the article title, the article body, the images, the context description, the recognized face expressions, the recognized actions, and/or the recognized objects. The cloud infrastructure 115 may provide for alt text generation with the LMM 140. For example, once the face-name identities are retrieved using the online matching technique, the system may prompt the LMM 140 using the retrieved names, associated face positional information, the article title, the article body, the images, the context description, the recognized face expressions, the recognized actions, and/or the recognized objects. This may generate a rich and contextually aware alt text that integrates both the retrieved names and contextual webpage information (such as article text and image descriptions). The LMM 140 may generate captions that adapt not only to the faces present but also to the broader context of the webpage, providing a more accurate and meaningful alt text description.

As indicated by block 250, the contextualized alt text may be communicated back to the endpoint device. As indicated by block 255, the cloud infrastructure 115 may continuously learn over time as new webpages are visited by the user and update the dynamic face database with each new page visit, allowing the system to improve over time. This updating mechanism may ensure that the face-name matching process becomes more accurate as the user's browsing history evolves. Additionally, reranked associations between face embeddings and names may be stored, helping the system to learn and adapt based at least in part on previous interactions. The reranking process may strengthen the matching process over time, leading to faster and more accurate convergence of face-name associations and providing a robust framework to handle the dynamic nature of web browsing.

Referring again to FIG. 1 for more details, the AI extension 110 may allow users to securely log in and may communicate with web accessibility as a service (WAaaS) provided by the cloud infrastructure 115 (e.g., Oracle's Web Accessibility as a Service (OWAAS) or the like). When the webpage 105 (or another webpage) is visited by a user using any suitable endpoint device, a web server may provide webpage content to the endpoint device for rendering with a browser of the endpoint device. The AI extension 110 may pass the text and images of the webpage 105 passed by to the cloud infrastructure 115 so that the web text and images are analyzed by the cloud infrastructure 115 providing the WAaaS and so that the cloud infrastructure 115 may generate alt text. In some embodiments, the AI extension 110 may parse the webpage 105 to extract relevant content such as web images, article text, headings, etc. and transmit the extracted content to the cloud infrastructure 115. In some embodiments, the AI extension 110 may transmit, or cause to be transmitted, the content of the webpage 105 from the endpoint device to the cloud infrastructure 115 so that the cloud infrastructure 115 may parse the content of the webpage 105 to extract relevant content.

The cloud infrastructure 115 may include a face detection and embedding engine (FDE) 120, a named entity recognition engine (NER) 125, personalized cloud storage 130, an online bipartite face matching engine (BFM) 135, and a large multimodal model (LMM) 140 that the cloud infrastructure 115 may use to provide the WAaaS and the contextual alt text generation for web images. The cloud infrastructure 115 may use the FDE 120 to perform person and face localization. The FDE 120 may analyze the images extracted from the webpage 105 to detect the presence of people and face bounding boxes in the images of the current webpage 105. In the previous example, the face detection may detect the faces of Narendra Modi and Virat Kohli. The face detection may detect two bounding boxes, one for each face. Face localization may be distinct from the face recognition that will follow.

Consequent to face localization, unique signatures of the faces (face embeddings) may be generated using the image data corresponding to the bounding boxes. Faces corresponding to the bounding boxes may be cropped out and passed through an embedding model to generate the unique signatures for the particular faces. The embedding may be used for matching the names to the faces. The cloud infrastructure 115 may use the FDE 120 for face embeddings generation. The FDE 120 may use an AI service for performing deep-learning-based image analysis (e.g., OCI Vision Service or the like) to generate face embeddings (which may correspond to unique signatures and/or mathematical representations of the faces). For each detected face, the FDE 120 may generate face embeddings. Probable person names may be associated with each face image 10 using the surrounding context. This approach may avoid the need for public PII data, ensuring privacy. These face embeddings may be stored in user's private and personalized cloud data storage 130.

The NER 125 may perform name entity extraction. As there may exists names of the people in the given web article corresponding to the faces in the web article images, the NER 125 may identify and extract the named identities (person names) from the web text. This may include the NER 125 identifying which are the main names mentioned in the particular article (e.g., using one of the previous examples, Narendra Modi and Virat Kohli may be identified from the text of the article).

So, having the names extracted from the text and the face bounding boxes from the image, one challenge is correlating them without using any face recognition model because conventional face recognition models are trained on large amounts of data that include PII. However, disclosed embodiments may perform the face recognition and correlation without using PII data or preexisting database. Moreover, disclosed embodiments may solve another major problem with existing face recognition models, which is that the existing face recognition models may not be able to recognize particular faces and names that the models have not been trained on, the existing face recognition models being static. Disclosed embodiments may dynamically identify faces and names in such scenarios, correlate the face bounding boxes and detected names, and store the corresponding data in the user's personalized cloud data storage 130.

Over time, as a user continues to browse more webpages specific to his or her interests and develop a browsing history, the WAaaS of the cloud infrastructure 115 may build a personalized database of face embeddings and associated person names stored in the user's personalized cloud data storage 130. Accordingly, the user's personalized cloud data storage 130 may continue to be updated and dynamically developed over time as more and more faces, names, and correlations may be determined.

The user's personalized cloud data storage 130 may be private storage space and dedicated to the user and not shared with other users. Thus, with a plurality of users, each user may have a user-personalized cloud data storage 130 with face-name recognitions as a function of the user's browsing that is not shared with any other user's personalized cloud data storage 130. This may ensure privacy and compliance with legal requirements, legal limits, and guidelines. Moreover, a user may not want face-name recognitions (e.g., of friends and family recognized from the user's browsing) shared publicly. Furthermore, the dynamic development of the user's personalized cloud data storage 130 with the face-name recognitions from the user's browsing further enhances the features provided to the user as disclosed herein.

The cloud infrastructure 115 may use the BFM 135 to perform online bipartite face matching to dynamically match the named entities to the detected faces. To identify names for each face, an online graph-matching technique may be employed by the BFM 135. A bipartite graph may be generated, updated, and used to map face embedding to person names.

The cloud infrastructure 115 may use the LMM 140 for contextualized alt text generation. The results of the bipartite matching, which may include positional and identity information corresponding to the identified names and matched faces, may be communicated to the LMM 140. Additionally, the extracted web images and text from the webpage 105 may be communicated to the LMM 140. The prompt may be dynamically generated in order to combine the context of the web article, the identified individuals, and their personal information. The cloud infrastructure 115 may use the LMM 140 to recognize the context of a webpage from the web text of the webpage, which may include the title and the body of the webpage (e.g., the title and the body of an article). The cloud infrastructure 115 may use the LMM 140 to also recognize the context of a webpage based in part on the images in the webpage.

The LMM 140 may generate accurate, descriptive, and personalized alt text for the images in the web article for provisioning to the webpage 105. The alt text may correspond to an alt text summary of the webpage 105. The cloud infrastructure 115 may communicate the contextualized alt text to the endpoint device for the embedding in the webpage 105. The browser and/or the AI extension 110 may embed the alt text in the webpage 105.

Disclosed embodiments may improve the facial recognition based on the person's browsing history over time. Consider the case where the user visits a new webpage containing images of people. The cloud infrastructure 115 may extract the faces of the people and match them against the database to retrieve their names. The cloud infrastructure 115 may summarize the context of the web text. The cloud infrastructure 115 may generate a contextualized alt text for the images on the given webpage. In addition, the current webpage context may be used to refine the database, specifically, the face embedding and name association. As the user visits various webpages containing face images over time, the edge weights between face embeddings and names may be refined. This process may be referred to as face-name re-ranking. This may lead to robust online face identification and alt text generation.

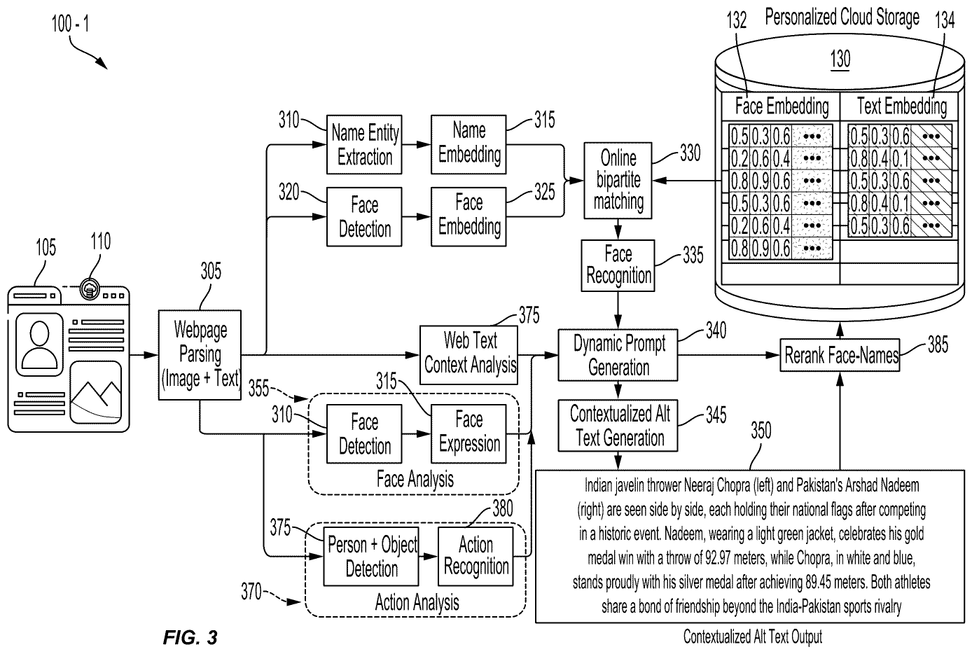

FIG. 3 illustrates a functional block diagram of the framework 100-1, in accordance with embodiments according to the present disclosure. One or a combination of the blocks may correspond to modules that the cloud infrastructure 115 may use to facilitate contextualized alt text generation. With a webpage parsing module 305, the webpage 105 is parsed to extract the images and web text. The extracted text may be communicated to a named entity extraction module 320. The extracted images may be communicated to a face detection module 320. In various embodiments, the extracted images may also be communicated to a face analysis module 355 and/or an action analysis module 370.

The extracted text (and, in some embodiments, the extracted images as well) may also be communicated to a web text analysis module 375. The web text analysis module 375 may use the LMM 140 or another LLM to recognize context from the extracted text and generate a description of the context of the article in the webpage 105. The description of the context may correspond to a brief summary of the article. The web text analysis module 375 may communicate the title of the article in the webpage 105 and the description of the context to a dynamic prompt generation module 340. In some embodiments, the web text analysis module 375 may communicate the images to the dynamic prompt generation module 340, as well.

As indicated by module 310, named entity extraction may be performed on the extracted web text to detect the named entities in the web text. This may involve filtering out other types of names (e.g., names of places). As indicated by module 315, name embedding may be executed so that, for every name detected an embedding is generated and stored in the user's personalized cloud storage 130. For the same person there could be two or more different names detected (e.g., Prime Minister Modi versus Prime Minister Narendra Modi). In such cases, each detected name may still have a separate name embedding, but the two or more corresponding name embeddings may be placed so that the distance between the embedding is minimal closely to one another in a cluster in dimensional/vector space. Additionally, the user's personalized cloud storage 130 may include previously stored text embeddings 134.

As indicated by module 320, face detection may be performed on the web images. As indicated by module 325, unique signatures called face embeddings may be generated. Additionally, the user's personalized cloud storage 130 may include previously stored face embeddings 132.

The user's personalized cloud data storage 130 may correspond to a bootstrapping dynamic face matching database. The face matching database may contain mappings between face embeddings 132 and name embeddings 134. At any given moment, the best possible mapping between names and faces may be maintained. Given that a person's web browsing is inherently dynamic, a specific methodology may be employed to recognize individuals in the provided images. This may be achieved without the need for pre-built knowledge graphs or fixed identities face recognition models. In some embodiments, the user's personalized cloud data storage 130 may initially not include any embedding when a user begins a browsing history. Then, over time, the user's personalized cloud data storage 130 may be populated with embeddings as the user browses and develop the user's browsing history. In some embodiments, the user's personalized cloud data storage 130 may initially be seeded with embeddings when a user begins a browsing history. Such a seeding may include embeddings of celebrities and popular or otherwise well-known figures gathered by the cloud infrastructure 115 from publicly available data sources.

As indicated by module 330, the name embeddings generated by module 315, the face embeddings generated by module 325, and the previously stored text embeddings 134 and face embeddings 132 may be fused together via the online bipartite matching. The online bipartite matching may also consume the previously stored name embeddings and face embedding that were previously stored in the user's personalized cloud storage 130. That may help generate correlations between potentially a plurality of names and potentially a plurality of faces. For example, say, there are only two faces detected in the web image and five names detected in the web text; or there could be two faces detected and two names detected; or there could be four faces detected and only one name detected. There could be any combination of N faces and M names that may be matched by the online bipartite matching without requiring a static database.

As indicated by module 335, face recognition results may be generated by the online bipartite matching. The face recognition results may be fed to the dynamic prompt generation, which is indicated by module 340. The dynamic prompt generation module 340 may use a prompt template with fixed portions and variable portions that may be adjusted based at least in part on input components. In some embodiments, the following may be the schema for the prompt for the LMM 140. The input components for the variables of the prompt may include:
Face Information: Names and positions (defined by bounding boxes) of individuals in the image from module 340.
Web Article Title: The title of the article providing context from module 375.
Web Article Description: Web text of the article or brief summary of the article from module 375.
Web Article Image: Associated image(s) of the web article from module 375.

The prompt structure of the prompt generated by module 340 may, for example, include:
Context Introduction: Start with a statement about the purpose of the alt text.
Face Descriptions: Include details about each person, their positions, webpage title, and web text.
Alt Text Generation: Conclude with a cohesive description that integrates all elements into a contextualized alt text.

As indicated by module 345, the contextual alt text generation may receive the prompt and generate the contextualized alt text output 350. Following is one example prompt and corresponding generated alt text:

### Sample Input Prompt

Generate an alt text for visually impaired person for the given image. The alt text needs to be contextualized and detailed based on the web article and other information like name of the people in the image. Provide output up to 30 words
Face information: Neeraj Chopra on the left side, Arshad Nadeem on the right side
Web article:
Title: EXCLUSIVE | No rivalry between Neeraj Chopra and Arshad Nadeem, just a ‘strong’friendship: Mother of Pakistan's Olympic gold medalist Web text: [Description of the article]
   Generated Contextualised Alt Text (generated by LMM 140)
Indian javelin thrower Neeraj Chopra (left) and Pakistan's Arshad Nadeem (right) are seen side by side, each holding their national flags after competing in a historic event. Nadeem, wearing a light green jacket, celebrates his gold medal win with a throw of 42.97 meters, while Chopra, in white and blue, stands proudly with his silver medal after achieving 39.45 meters. Both athletes share a bond of friendship beyond the India-Pakistan sports rivalry.”

Thus, contextualized alt text 350 for an image may be generated using the LMM 140. The people in the image may already be identified in the previous steps. In addition, web text, positional information of faces, and the corresponding web article image may be used in generating the alt text 350.

As indicated by module 355, in some embodiments, face analysis may be performed on the web images. The face analysis 355 may include face detection 360 then facial expression recognition 365 to generate face analysis results. In some embodiments, the action analysis may include using the LMM 140 to make face recognitions and expression recognitions. The face analysis results may also be combined into the dynamic prompt generation 340.

As indicated by module 370, in some embodiments, action analysis may be performed on the web images. The action analysis 370 may include person and object detection 375 then action recognition 380 to generate action analysis results. In some embodiments, the action analysis results may include not only action recognitions but also object recognitions. In some embodiments, the action analysis may include using the LMM 140 to make action recognitions and object recognitions. The action analysis results may also be combined into the dynamic prompt generation 340.

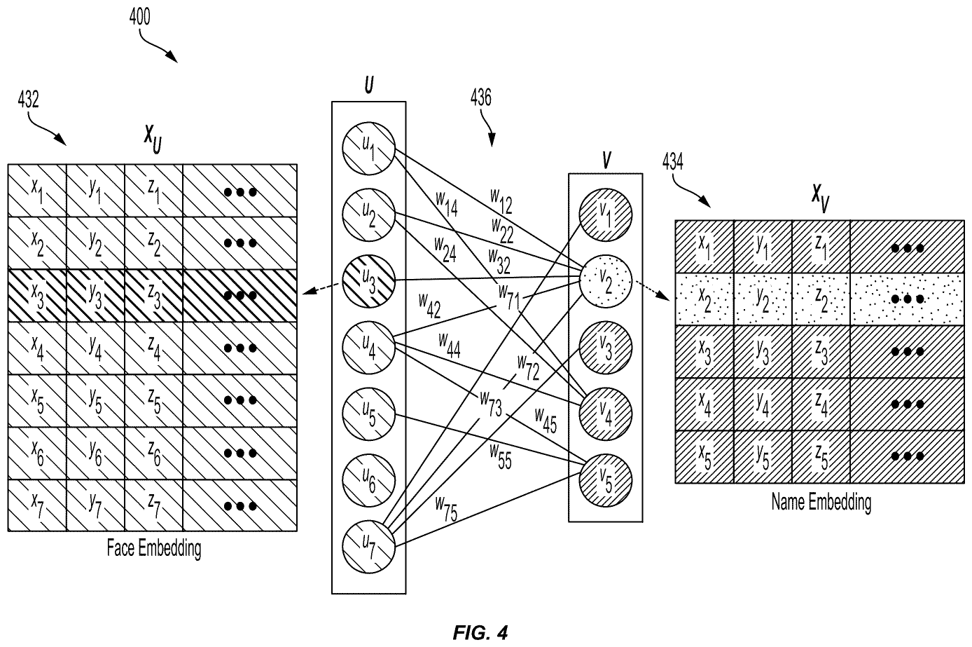

Now referring in more detail to the online bipartite matching 330, the face matching problem may be framed as an online bipartite graph. FIG. 4 illustrates online bipartite graph matching 400, in accordance with embodiments according to the present disclosure. A graph 432 may represent the face embeddings. This may, for example, include the new generated face embeddings from module 325 and the previously stored face embeddings 132 of FIG. 3. A graph 434 may represent the name embeddings. This may, for example, include the new generated face embeddings from module 315 and the previously stored face embeddings 134 of FIG. 3. Edges 436 may define how correlated particular names are with particular faces. Only some of the edges 436 are illustrated for the sake of clarity, however, every U node may be connected to every V node with an edge 436, with each edge 436 having any of various weight values (e.g., 0.01, 0.1, 0.2, 0.5, etc. on a scale of 0 to 1).

The online bipartite graph may be represented by G=(U, V, E), where: U may represent the set of face embeddings (size n) that may correspond to a cluster of possibly related faces; V may represent the set of name embeddings (size m) that may correspond to a cluster of possibly related names; and each edge weight in E may signify the probability that a particular name in V corresponds to a given face in U. The edge weights may correspond to the co-occurrence of the faces and the names. As the user visits various webpages containing face images over time, the weights of the graph may be updated dynamically. It is possible that the same faces may reappear, while new faces and corresponding names may also be introduced.

In the illustrated example, x₃, y₃, and z₃ may correspond to face embeddings. A cluster of x₃, y₃, and z₃ may be represented by u₃. Likewise, x₂, y₂, and z₂ may correspond to name embeddings. A cluster of x₂, y₂, and z₂ may be represented by v₂. A cluster may have one or more embeddings. In some embodiments, a cluster may be built based at least in part on a K-means algorithm and/or the like clustering algorithm.

Say, for example, the user has seen Prime Minister Modi in multiple images based on the user's past browsing history. The corresponding face embeddings may be place in mutual proximity in the graph 432. Then, the cluster may be filtered using a K-means clustering algorithm, and the result may be represented by u₃. Likewise, various names of Prime Minister Modi in multiple web articles may have name embeddings place in mutual proximity in the graph 434. The cluster may be filtered using a K-means clustering algorithm, and the result may be represented by v₃.

At the start of a user's browsing history, all the names and all the faces in a webpage may be connected with edges of 436 low confidence (weight) values. A probabilistic heuristic algorithm may assign higher weights based at least in part on, for example, a face bounding box size being bigger in the image being mapped to the main name in the article, which may be identified with a heuristic based on how many times the name appears in the web text, for example. As the user's browsing history develops and particular names and faces are again recognized, a same or similar name may be identified and associated with the same cluster. Likewise, a same or similar face may be identified and associated with the same cluster. Accordingly, certain of the edge weights may be adjusted (e.g., increased in weight based on increased confidence of correlation).

The online bipartite matching 330 may provide for optimal matching in single face-name scenarios. In certain cases, when a webpage 105 features a single face in U and a single named entity in V, this scenario may provide the optimal matching opportunity. With only one face and one name present, the edge weight 436 between them may indicate the highest probability of a match. This unique pairing may serve as the most reliable clue for identification finalizing the mapping between the face embedding and the name embedding.

Additionally or alternatively, the cloud infrastructure 115 may perform face-name re-ranking to refine face-name matching. Referring again to FIG. 3, the contextualized alt text output 350 may be passed as input to a face-name re-ranking module 385. A re-ranking process may be based at least in part on web text and the alt text 350 generated by the LMM 140. After generating initial matches between face embeddings and names, the cloud infrastructure 115 may re-rank the matches by analyzing the web article content and generated alt text 350.

The face-name re-ranking module 385 may use the LMM 140 to compare the generated alt text 350 to the original face-name mappings to identify further opportunities for refinement of the face-name matching, to improve the quality of the matching. If the LMM-generated alt text reinforces certain face-name associations, the cloud infrastructure 115 may may adjust the edge weights of the bipartite graph accordingly. This re-ranking may dynamically refine the edge weights of face-name matches by incorporating both visual and textual information. The reranking process may accelerate convergence of the face-name matching by continuously updating the edge weights, improving accuracy with each iteration, and providing greater robustness by considering the context of the webpage.

The process may be explained below through an example. The LMM 140 may be prompted to score the mapping between the faces (with face information corresponding to bounding boxes) and the names taking the current web text into consideration:

Prompt:
Rerank query: Based on the given {web text}, {input image} and {generated alt text}, and
{face information}, now you need to focus on robustness and accuracy of the face names.
Rerank the face name pairs based on article and alt text context in the {output format}
Output format: “Confidence”: {name}:{score}
Output:
This confidence score update reflects their clear identification based on face bounding
boxes, country flags and contextual information from the article.
“Confidence”: {
“Neeraj Chopra”: 0.99,
“Arshad Nadeem”: 0.93
}

With this output, the weights of the online bipartite matching algorithm may be updated accordingly, refining future predictions and caption generation based on the evolving context. The edges weights 436 (which may correspond to confidence scores) may be probabilistically updated to normalize the graph (rather than just replaced with the new confidence scores) in order to quickly converge the face-name matching. This reranking process may allow for a dynamic adjustment of face-name associations, improving accuracy by considering both visual and textual information in real-time. Thus, the cloud infrastructure 115 may employ a continuous learning methodology. Furthermore, the disclosed re-ranking method may prove highly effective in improving the confidence scores for bipartite matching between names and faces. By considering the article's context, the system can more accurately associate individuals with their visual representations, leading to more precise and reliable alt text generation.

Accordingly, disclosed systems and methods may effectively provide for accurate and contextually relevant alt text generation across diverse and complex cases, for example, a wide range of situations where the number of named entities and detected faces in images vary, including instances with background individuals and well-known personalities. The disclosed approach may prove robust in handling all possible combinations, consistently producing contextually relevant alt text for the associated web article that demonstrates superior understanding and descriptions of image content within the context of webpages. The disclosed approach may be adaptable to varying ratios of named entities and detected faces in order to provide accurate identification and description of both known and unknown personalities with context-aware alt text that corresponds to context-rich, accurate image descriptions.

Disclosed systems and methods may successfully incorporate names of individuals from the web article, even when the number of people in the image and text differs. Additionally, disclosed systems and methods may handle images with multiple background individuals, outperforming competing solutions that struggle with facial information alignment and contextual relevance. Advantages disclosed systems and methods may further include the following. Disclosed embodiments may not be dependent on pre-built knowledge graphs or static identity-based face recognition models, as gathering such globally representative PII face data is impractical. Instead, disclosed systems and methods may leverage the user's personal browsing history to dynamically update face identities and assign names based on named entities from web articles, ensuring compliance with privacy standards. The disclosed systems and methods may handle out-of-dictionary faces encountered on the web, as the graphs are continuously updated in real-time using the user's browsing history. The disclosed systems and methods may be extensible, enabling the generation of richer alt text by integrating metadata from multiple specialized sources, tailored to specific industry use cases. The disclosed systems and methods may include a reranking mechanism that may enable faster convergence of online face recognition and may improve the robustness of the overall system.

Infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

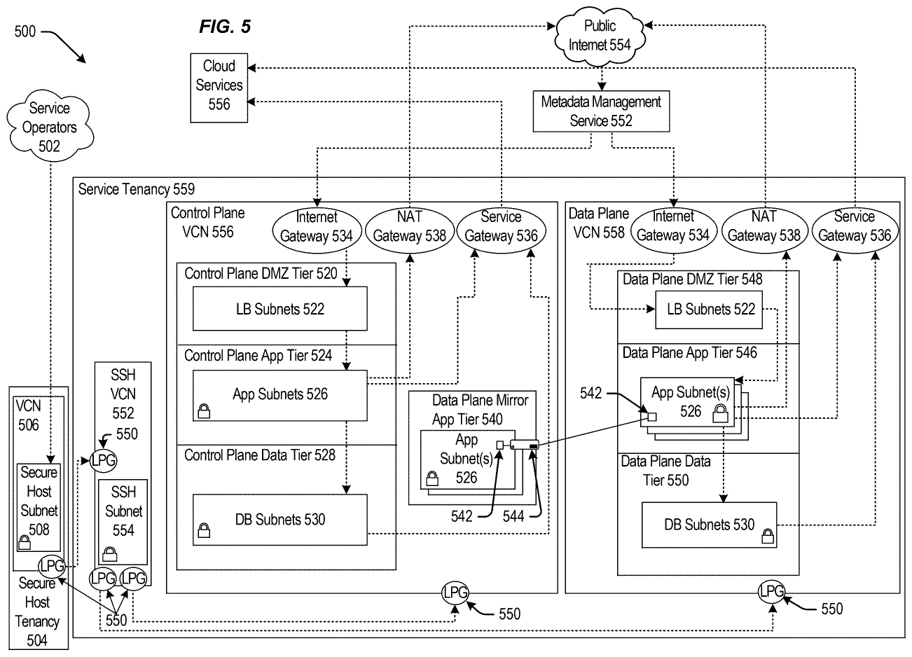

FIG. 5 is a block diagram 500 illustrating an example pattern of an IaaS architecture, according to at least one embodiment. Service operators 502 can be communicatively coupled to a secure host tenancy 504 that can include a virtual cloud network (VCN) 506 and a secure host subnet 508. In some examples, the service operators 502 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 506 and/or the Internet.

The VCN 506 can include a local peering gateway (LPG) 510 that can be communicatively coupled to a secure shell (SSH) VCN 512 via an LPG 510 contained in the SSH VCN 512. The SSH VCN 512 can include an SSH subnet 514, and the SSH VCN 512 can be communicatively coupled to a control plane VCN 516 via the LPG 510 contained in the control plane VCN 516. Also, the SSH VCN 512 can be communicatively coupled to a data plane VCN 518 via an LPG 510. The control plane VCN 516 and the data plane VCN 518 can be contained in a service tenancy 519 that can be owned and/or operated by the IaaS provider.

The control plane VCN 516 can include a control plane demilitarized zone (DMZ) tier 520 that acts as a perimeter network (e.g., portions of a corporate network between the corporate intranet and external networks). The DMZ-based servers may have restricted responsibilities and help keep breaches contained. Additionally, the DMZ tier 520 can include one or more load balancer (LB) subnet(s) 522, a control plane app tier 524 that can include app subnet(s) 526, a control plane data tier 528 that can include database (DB) subnet(s) 530 (e.g., frontend DB subnet(s) and/or backend DB subnet(s)). The LB subnet(s) 522 contained in the control plane DMZ tier 520 can be communicatively coupled to the app subnet(s) 526 contained in the control plane app tier 524 and an Internet gateway 534 that can be contained in the control plane VCN 516, and the app subnet(s) 526 can be communicatively coupled to the DB subnet(s) 530 contained in the control plane data tier 528 and a service gateway 536 and a network address translation (NAT) gateway 538. The control plane VCN 516 can include the service gateway 536 and the NAT gateway 538.

The control plane VCN 516 can include a data plane mirror app tier 540 that can include app subnet(s) 526. The app subnet(s) 526 contained in the data plane mirror app tier 540 can include a virtual network interface controller (VNIC) 542 that can execute a compute instance 544. The compute instance 544 can communicatively couple the app subnet(s) 526 of the data plane mirror app tier 540 to app subnet(s) 526 that can be contained in a data plane app tier 546.

The data plane VCN 518 can include the data plane app tier 546, a data plane DMZ tier 548, and a data plane data tier 550. The data plane DMZ tier 548 can include LB subnet(s) 522 that can be communicatively coupled to the app subnet(s) 526 of the data plane app tier 546 and the Internet gateway 534 of the data plane VCN 518. The app subnet(s) 526 can be communicatively coupled to the service gateway 536 of the data plane VCN 518 and the NAT gateway 538 of the data plane VCN 518. The data plane data tier 550 can also include the DB subnet(s) 530 that can be communicatively coupled to the app subnet(s) 526 of the data plane app tier 546.

The Internet gateway 534 of the control plane VCN 516 and of the data plane VCN 518 can be communicatively coupled to a metadata management service 552 that can be communicatively coupled to public Internet 554. Public Internet 554 can be communicatively coupled to the NAT gateway 538 of the control plane VCN 516 and of the data plane VCN 518. The service gateway 536 of the control plane VCN 516 and of the data plane VCN 518 can be communicatively coupled to cloud services 556.

In some examples, the service gateway 536 of the control plane VCN 516 or of the data plane VCN 518 can make application programming interface (API) calls to cloud services 556 without going through public Internet 554. The API calls to cloud services 556 from the service gateway 536 can be one-way: the service gateway 536 can make API calls to cloud services 556, and cloud services 556 can send requested data to the service gateway 536. However, cloud services 556 may not initiate API calls to the service gateway 536.

In some examples, the secure host tenancy 504 can be directly connected to the service tenancy 519, which may be otherwise isolated. The secure host subnet 508 can communicate with the SSH subnet 514 through an LPG 510 that may enable two-way communication over an otherwise isolated system. Connecting the secure host subnet 508 to the SSH subnet 514 may give the secure host subnet 508 access to other entities within the service tenancy 519.

The control plane VCN 516 may allow users of the service tenancy 519 to set up or otherwise provision desired resources. Desired resources provisioned in the control plane VCN 516 may be deployed or otherwise used in the data plane VCN 518. In some examples, the control plane VCN 516 can be isolated from the data plane VCN 518, and the data plane mirror app tier 540 of the control plane VCN 516 can communicate with the data plane app tier 546 of the data plane VCN 518 via VNICs 542 that can be contained in the data plane mirror app tier 540 and the data plane app tier 546.

In some examples, users of the system, or customers, can make requests, for example create, read, update, or delete (CRUD) operations, through public Internet 554 that can communicate the requests to the metadata management service 552. The metadata management service 552 can communicate the request to the control plane VCN 516 through the Internet gateway 534. The request can be received by the LB subnet(s) 522 contained in the control plane DMZ tier 520. The LB subnet(s) 522 may determine that the request is valid, and in response to this determination, the LB subnet(s) 522 can transmit the request to app subnet(s) 526 contained in the control plane app tier 524. If the request is validated and requires a call to public Internet 554, the call to public Internet 554 may be transmitted to the NAT gateway 538 that can make the call to public Internet 554. Metadata that may be desired to be stored by the request can be stored in the DB subnet(s) 530.

In some examples, the data plane mirror app tier 540 can facilitate direct communication between the control plane VCN 516 and the data plane VCN 518. For example, changes, updates, or other suitable modifications to configuration may be desired to be applied to the resources contained in the data plane VCN 518. Via a VNIC 542, the control plane VCN 516 can directly communicate with, and can thereby execute the changes, updates, or other suitable modifications to configuration to, resources contained in the data plane VCN 518.

In some embodiments, the control plane VCN 516 and the data plane VCN 518 can be contained in the service tenancy 519. In this case, the user, or the customer, of the system may not own or operate either the control plane VCN 516 or the data plane VCN 518. Instead, the IaaS provider may own or operate the control plane VCN 516 and the data plane VCN 518, both of which may be contained in the service tenancy 519. This embodiment can enable isolation of networks that may prevent users or customers from interacting with other users', or other customers', resources. Also, this embodiment may allow users or customers of the system to store databases privately without needing to rely on public Internet 554, which may not have a desired level of threat prevention, for storage.

In other embodiments, the LB subnet(s) 522 contained in the control plane VCN 516 can be configured to receive a signal from the service gateway 536. In this embodiment, the control plane VCN 516 and the data plane VCN 518 may be configured to be called by a customer of the IaaS provider without calling public Internet 554. Customers of the IaaS provider may desire this embodiment since database(s) that the customers use may be controlled by the IaaS provider and may be stored on the service tenancy 519, which may be isolated from public Internet 554.

FIG. 6 is a block diagram 600 illustrating another example pattern of an IaaS architecture, according to at least one embodiment. Service operators 602 (e.g., service operators 502 of FIG. 5) can be communicatively coupled to a secure host tenancy 604 (e.g., the secure host tenancy 504 of FIG. 5) that can include a virtual cloud network (VCN) 606 (e.g., the VCN 506 of FIG. 5) and a secure host subnet 608 (e.g., the secure host subnet 508 of FIG. 5). The VCN 606 can include a local peering gateway (LPG) 610 (e.g., the LPG 510 of FIG. 5) that can be communicatively coupled to a secure shell (SSH) VCN 612 (e.g., the SSH VCN 512 of FIG. 5) via an LPG 510 contained in the SSH VCN 612. The SSH VCN 612 can include an SSH subnet 614 (e.g., the SSH subnet 514 of FIG. 5), and the SSH VCN 612 can be communicatively coupled to a control plane VCN 616 (e.g., the control plane VCN 516 of FIG. 5) via an LPG 610 contained in the control plane VCN 616. The control plane VCN 616 can be contained in a service tenancy 619 (e.g., the service tenancy 519 of FIG. 5), and the data plane VCN 618 (e.g., the data plane VCN 518 of FIG. 5) can be contained in a customer tenancy 621 that may be owned or operated by users, or customers, of the system.

The control plane VCN 616 can include a control plane DMZ tier 620 (e.g., the control plane DMZ tier 520 of FIG. 5) that can include LB subnet(s) 622 (e.g., LB subnet(s) 522 of FIG. 5), a control plane app tier 624 (e.g., the control plane app tier 524 of FIG. 5) that can include app subnet(s) 626 (e.g., app subnet(s) 526 of FIG. 5), a control plane data tier 628 (e.g., the control plane data tier 528 of FIG. 5) that can include database (DB) subnet(s) 630 (e.g., similar to DB subnet(s) 530 of FIG. 5). The LB subnet(s) 622 contained in the control plane DMZ tier 620 can be communicatively coupled to the app subnet(s) 626 contained in the control plane app tier 624 and an Internet gateway 634 (e.g., the Internet gateway 534 of FIG. 5) that can be contained in the control plane VCN 616, and the app subnet(s) 626 can be communicatively coupled to the DB subnet(s) 630 contained in the control plane data tier 628 and a service gateway 636 (e.g., the service gateway 536 of FIG. 5) and a network address translation (NAT) gateway 638 (e.g., the NAT gateway 538 of FIG. 5). The control plane VCN 616 can include the service gateway 636 and the NAT gateway 638.

The control plane VCN 616 can include a data plane mirror app tier 640 (e.g., the data plane mirror app tier 540 of FIG. 5) that can include app subnet(s) 626. The app subnet(s) 626 contained in the data plane mirror app tier 640 can include a virtual network interface controller (VNIC) 642 (e.g., the VNIC of 542) that can execute a compute instance 644 (e.g., similar to the compute instance 544 of FIG. 5). The compute instance 644 can facilitate communication between the app subnet(s) 626 of the data plane mirror app tier 640 and the app subnet(s) 626 that can be contained in a data plane app tier 646 (e.g., the data plane app tier 546 of FIG. 5) via the VNIC 642 contained in the data plane mirror app tier 640 and the VNIC 642 contained in the data plane app tier 646.

The Internet gateway 634 contained in the control plane VCN 616 can be communicatively coupled to a metadata management service 652 (e.g., the metadata management service 552 of FIG. 5) that can be communicatively coupled to public Internet 654 (e.g., public Internet 554 of FIG. 5). Public Internet 654 can be communicatively coupled to the NAT gateway 638 contained in the control plane VCN 616. The service gateway 636 contained in the control plane VCN 616 can be communicatively coupled to cloud services 656 (e.g., cloud services 556 of FIG. 5).

In some examples, the data plane VCN 618 can be contained in the customer tenancy 621. In this case, the IaaS provider may provide the control plane VCN 616 for each customer, and the IaaS provider may, for each customer, set up a unique compute instance 644 that is contained in the service tenancy 619. Each compute instance 644 may allow communication between the control plane VCN 616, contained in the service tenancy 619, and the data plane VCN 618 that is contained in the customer tenancy 621. The compute instance 644 may allow resources, that are provisioned in the control plane VCN 616 that is contained in the service tenancy 619, to be deployed or otherwise used in the data plane VCN 618 that is contained in the customer tenancy 621.

In other examples, the customer of the IaaS provider may have databases that live in the customer tenancy 621. In this example, the control plane VCN 616 can include the data plane mirror app tier 640 that can include app subnet(s) 626. The data plane mirror app tier 640 can reside in the data plane VCN 618, but the data plane mirror app tier 640 may not live in the data plane VCN 618. That is, the data plane mirror app tier 640 may have access to the customer tenancy 621, but the data plane mirror app tier 640 may not exist in the data plane VCN 618 or be owned or operated by the customer of the IaaS provider. The data plane mirror app tier 640 may be configured to make calls to the data plane VCN 618 but may not be configured to make calls to any entity contained in the control plane VCN 616. The customer may desire to deploy or otherwise use resources in the data plane VCN 618 that are provisioned in the control plane VCN 616, and the data plane mirror app tier 640 can facilitate the desired deployment, or other usage of resources, of the customer.

In some embodiments, the customer of the IaaS provider can apply filters to the data plane VCN 618. In this embodiment, the customer can determine what the data plane VCN 618 can access, and the customer may restrict access to public Internet 654 from the data plane VCN 618. The IaaS provider may not be able to apply filters or otherwise control access of the data plane VCN 618 to any outside networks or databases. Applying filters and controls by the customer onto the data plane VCN 618, contained in the customer tenancy 621, can help isolate the data plane VCN 618 from other customers and from public Internet 654.

In some embodiments, cloud services 656 can be called by the service gateway 636 to access services that may not exist on public Internet 654, on the control plane VCN 616, or on the data plane VCN 618. The connection between cloud services 656 and the control plane VCN 616 or the data plane VCN 618 may not be live or continuous. Cloud services 656 may exist on a different network owned or operated by the IaaS provider. Cloud services 656 may be configured to receive calls from the service gateway 636 and may be configured to not receive calls from public Internet 654. Some cloud services 656 may be isolated from other cloud services 656, and the control plane VCN 616 may be isolated from cloud services 656 that may not be in the same region as the control plane VCN 616. For example, the control plane VCN 616 may be located in “Region 5,” and cloud service “Deployment 5,” may be located in Region 5 and in “Region 6.” If a call to Deployment 5 is made by the service gateway 636 contained in the control plane VCN 616 located in Region 5, the call may be transmitted to Deployment 5 in Region 5. In this example, the control plane VCN 616, or Deployment 5 in Region 5, may not be communicatively coupled to, or otherwise in communication with, Deployment 5 in Region 6.

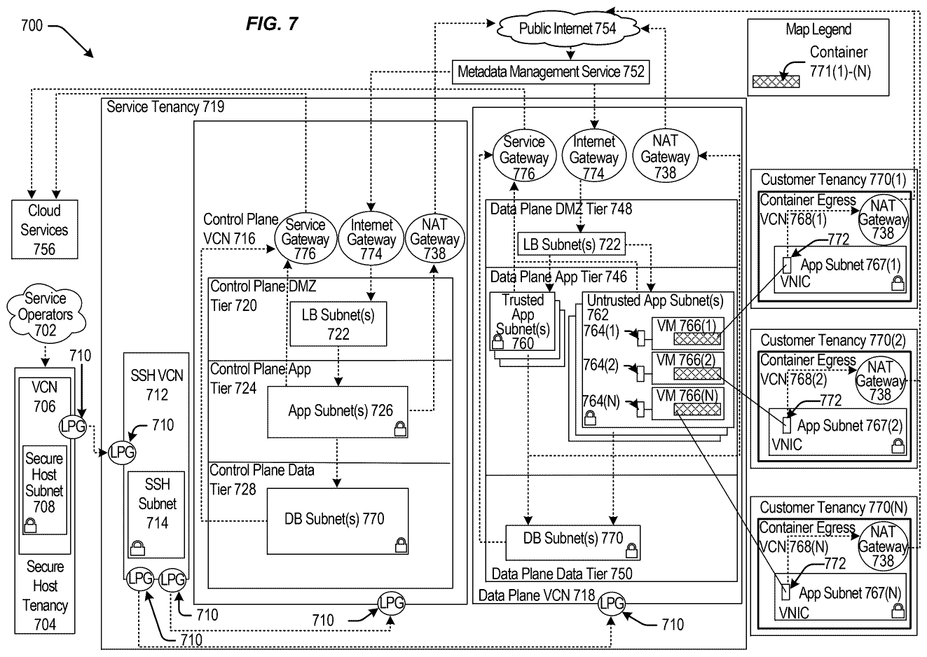

FIG. 7 is a block diagram 700 illustrating another example pattern of an IaaS architecture, according to at least one embodiment. Service operators 702 (e.g., service operators 502 of FIG. 5) can be communicatively coupled to a secure host tenancy 704 (e.g., the secure host tenancy 504 of FIG. 5) that can include a virtual cloud network (VCN) 706 (e.g., the VCN 506 of FIG. 5) and a secure host subnet 708 (e.g., the secure host subnet 508 of FIG. 5). The VCN 706 can include an LPG 710 (e.g., the LPG 510 of FIG. 5) that can be communicatively coupled to an SSH VCN 712 (e.g., the SSH VCN 512 of FIG. 5) via an LPG 710 contained in the SSH VCN 712. The SSH VCN 712 can include an SSH subnet 714 (e.g., the SSH subnet 514 of FIG. 5), and the SSH VCN 712 can be communicatively coupled to a control plane VCN 716 (e.g., the control plane VCN 516 of FIG. 5) via an LPG 710 contained in the control plane VCN 716 and to a data plane VCN 718 (e.g., the data plane 518 of FIG. 5) via an LPG 710 contained in the data plane VCN 718. The control plane VCN 716 and the data plane VCN 718 can be contained in a service tenancy 719 (e.g., the service tenancy 519 of FIG. 5).

The control plane VCN 716 can include a control plane DMZ tier 720 (e.g., the control plane DMZ tier 520 of FIG. 5) that can include load balancer (LB) subnet(s) 722 (e.g., LB subnet(s) 522 of FIG. 5), a control plane app tier 724 (e.g., the control plane app tier 524 of FIG. 5) that can include app subnet(s) 726 (e.g., similar to app subnet(s) 526 of FIG. 5), a control plane data tier 728 (e.g., the control plane data tier 528 of FIG. 5) that can include DB subnet(s) 730. The LB subnet(s) 722 contained in the control plane DMZ tier 720 can be communicatively coupled to the app subnet(s) 726 contained in the control plane app tier 724 and to an Internet gateway 734 (e.g., the Internet gateway 534 of FIG. 5) that can be contained in the control plane VCN 716, and the app subnet(s) 726 can be communicatively coupled to the DB subnet(s) 730 contained in the control plane data tier 728 and to a service gateway 736 (e.g., the service gateway of FIG. 5) and a network address translation (NAT) gateway 738 (e.g., the NAT gateway 538 of FIG. 5). The control plane VCN 716 can include the service gateway 736 and the NAT gateway 738.

The data plane VCN 718 can include a data plane app tier 746 (e.g., the data plane app tier 546 of FIG. 5), a data plane DMZ tier 748 (e.g., the data plane DMZ tier 548 of FIG. 5), and a data plane data tier 750 (e.g., the data plane data tier 550 of FIG. 5). The data plane DMZ tier 748 can include LB subnet(s) 722 that can be communicatively coupled to trusted app subnet(s) 760 and untrusted app subnet(s) 762 of the data plane app tier 746 and the Internet gateway 734 contained in the data plane VCN 718. The trusted app subnet(s) 760 can be communicatively coupled to the service gateway 736 contained in the data plane VCN 718, the NAT gateway 738 contained in the data plane VCN 718, and DB subnet(s) 730 contained in the data plane data tier 750. The untrusted app subnet(s) 762 can be communicatively coupled to the service gateway 736 contained in the data plane VCN 718 and DB subnet(s) 730 contained in the data plane data tier 750. The data plane data tier 750 can include DB subnet(s) 730 that can be communicatively coupled to the service gateway 736 contained in the data plane VCN 718.

The untrusted app subnet(s) 762 can include one or more primary VNICs 764(1)-(N) that can be communicatively coupled to tenant virtual machines (VMs) 766(1)-(N). Each tenant VM 766(1)-(N) can be communicatively coupled to a respective app subnet 767(1)-(N) that can be contained in respective container egress VCNs 768(1)-(N) that can be contained in respective customer tenancies 770(1)-(N). Respective secondary VNICs 772(1)-(N) can facilitate communication between the untrusted app subnet(s) 762 contained in the data plane VCN 718 and the app subnet contained in the container egress VCNs 768(1)-(N). Each container egress VCNs 768(1)-(N) can include a NAT gateway 738 that can be communicatively coupled to public Internet 754 (e.g., public Internet 554 of FIG. 5).

The Internet gateway 734 contained in the control plane VCN 716 and contained in the data plane VCN 718 can be communicatively coupled to a metadata management service 752 (e.g., the metadata management system 552 of FIG. 5) that can be communicatively coupled to public Internet 754. Public Internet 754 can be communicatively coupled to the NAT gateway 738 contained in the control plane VCN 716 and contained in the data plane VCN 718. The service gateway 736 contained in the control plane VCN 716 and contained in the data plane VCN 718 can be communicatively coupled to cloud services 756.

In some embodiments, the data plane VCN 718 can be integrated with customer tenancies 770. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 746. Code to run the function may be executed in the VMs 766(1)-(N), and the code may not be configured to run anywhere else on the data plane VCN 718. Each VM 766(1)-(N) may be connected to one customer tenancy 770. Respective containers 771(1)-(N) contained in the VMs 766(1)-(N) may be configured to run the code. In this case, there can be a dual isolation (e.g., the containers 771(1)-(N) running code, where the containers 771(1)-(N) may be contained in at least the VM 766(1)-(N) that are contained in the untrusted app subnet(s) 762), which may help prevent incorrect or otherwise undesirable code from damaging the network of the IaaS provider or from damaging a network of a different customer. The containers 771(1)-(N) may be communicatively coupled to the customer tenancy 770 and may be configured to transmit or receive data from the customer tenancy 770. The containers 771(1)-(N) may not be configured to transmit or receive data from any other entity in the data plane VCN 718. Upon completion of running the code, the IaaS provider may kill or otherwise dispose of the containers 771(1)-(N).

In some embodiments, the trusted app subnet(s) 760 may run code that may be owned or operated by the IaaS provider. In this embodiment, the trusted app subnet(s) 760 may be communicatively coupled to the DB subnet(s) 730 and be configured to execute CRUD operations in the DB subnet(s) 730. The untrusted app subnet(s) 762 may be communicatively coupled to the DB subnet(s) 730, but in this embodiment, the untrusted app subnet(s) may be configured to execute read operations in the DB subnet(s) 730. The containers 771(1)-(N) that can be contained in the VM 766(1)-(N) of each customer and that may run code from the customer may not be communicatively coupled with the DB subnet(s) 730.

In other embodiments, the control plane VCN 716 and the data plane VCN 718 may not be directly communicatively coupled. In this embodiment, there may be no direct communication between the control plane VCN 716 and the data plane VCN 718. However, communication can occur indirectly through at least one method. An LPG 710 may be established by the IaaS provider that can facilitate communication between the control plane VCN 716 and the data plane VCN 718. In another example, the control plane VCN 716 or the data plane VCN 718 can make a call to cloud services 756 via the service gateway 736. For example, a call to cloud services 756 from the control plane VCN 716 can include a request for a service that can communicate with the data plane VCN 718.

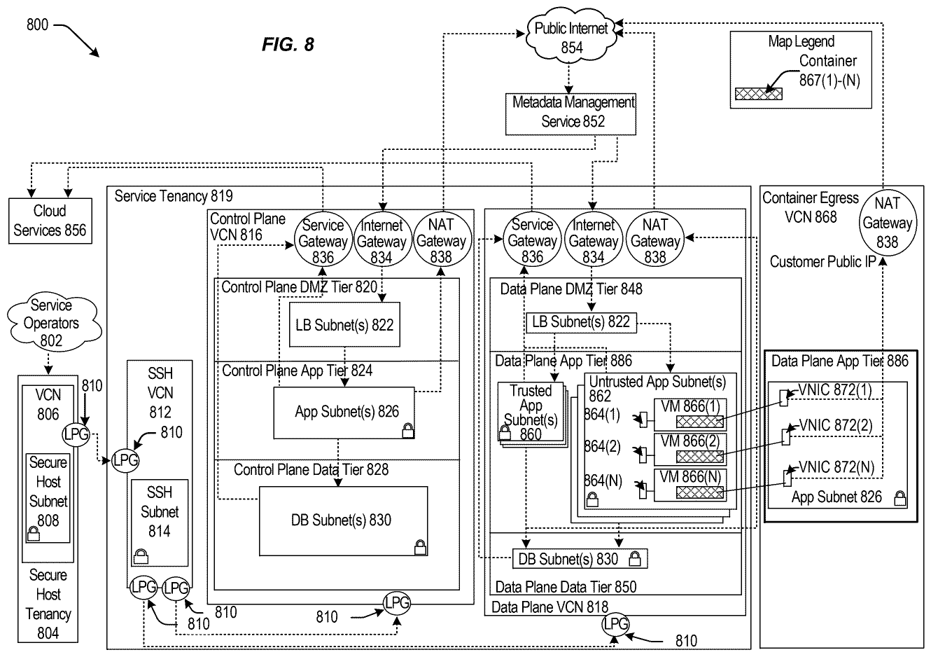

FIG. 8 is a block diagram 800 illustrating another example pattern of an IaaS architecture, according to at least one embodiment. Service operators 802 (e.g., service operators 502 of FIG. 5) can be communicatively coupled to a secure host tenancy 804 (e.g., the secure host tenancy 504 of FIG. 5) that can include a virtual cloud network (VCN) 806 (e.g., the VCN 506 of FIG. 5) and a secure host subnet 808 (e.g., the secure host subnet 508 of FIG. 5). The VCN 806 can include an LPG 810 (e.g., the LPG 510 of FIG. 5) that can be communicatively coupled to an SSH VCN 812 (e.g., the SSH VCN 512 of FIG. 5) via an LPG 810 contained in the SSH VCN 812. The SSH VCN 812 can include an SSH subnet 814 (e.g., the SSH subnet 514 of FIG. 5), and the SSH VCN 812 can be communicatively coupled to a control plane VCN 816 (e.g., the control plane VCN 516 of FIG. 5) via an LPG 810 contained in the control plane VCN 816 and to a data plane VCN 818 (e.g., the data plane 518 of FIG. 5) via an LPG 810 contained in the data plane VCN 818. The control plane VCN 816 and the data plane VCN 818 can be contained in a service tenancy 819 (e.g., the service tenancy 519 of FIG. 5).

The control plane VCN 816 can include a control plane DMZ tier 820 (e.g., the control plane DMZ tier 520 of FIG. 5) that can include LB subnet(s) 822 (e.g., LB subnet(s) 522 of FIG. 5), a control plane app tier 824 (e.g., the control plane app tier 524 of FIG. 5) that can include app subnet(s) 826 (e.g., app subnet(s) 526 of FIG. 5), a control plane data tier 828 (e.g., the control plane data tier 528 of FIG. 5) that can include DB subnet(s) 830 (e.g., DB subnet(s) 730 of FIG. 7). The LB subnet(s) 822 contained in the control plane DMZ tier 820 can be communicatively coupled to the app subnet(s) 826 contained in the control plane app tier 824 and to an Internet gateway 834 (e.g., the Internet gateway 534 of FIG. 5) that can be contained in the control plane VCN 816, and the app subnet(s) 826 can be communicatively coupled to the DB subnet(s) 830 contained in the control plane data tier 828 and to a service gateway 836 (e.g., the service gateway of FIG. 5) and a network address translation (NAT) gateway 838 (e.g., the NAT gateway 538 of FIG. 5). The control plane VCN 816 can include the service gateway 836 and the NAT gateway 838.

The data plane VCN 818 can include a data plane app tier 846 (e.g., the data plane app tier 546 of FIG. 5), a data plane DMZ tier 848 (e.g., the data plane DMZ tier 548 of FIG. 5), and a data plane data tier 850 (e.g., the data plane data tier 550 of FIG. 5). The data plane DMZ tier 848 can include LB subnet(s) 822 that can be communicatively coupled to trusted app subnet(s) 860 (e.g., trusted app subnet(s) 760 of FIG. 7) and untrusted app subnet(s) 862 (e.g., untrusted app subnet(s) 762 of FIG. 7) of the data plane app tier 846 and the Internet gateway 834 contained in the data plane VCN 818. The trusted app subnet(s) 860 can be communicatively coupled to the service gateway 836 contained in the data plane VCN 818, the NAT gateway 838 contained in the data plane VCN 818, and DB subnet(s) 830 contained in the data plane data tier 850. The untrusted app subnet(s) 862 can be communicatively coupled to the service gateway 836 contained in the data plane VCN 818 and DB subnet(s) 830 contained in the data plane data tier 850. The data plane data tier 850 can include DB subnet(s) 830 that can be communicatively coupled to the service gateway 836 contained in the data plane VCN 818.

The untrusted app subnet(s) 862 can include primary VNICs 864(1)-(N) that can be communicatively coupled to tenant virtual machines (VMs) 866(1)-(N) residing within the untrusted app subnet(s) 862. Each tenant VM 866(1)-(N) can run code in a respective container 867(1)-(N), and be communicatively coupled to an app subnet 826 that can be contained in a data plane app tier 846 that can be contained in a container egress VCN 868. Respective secondary VNICs 872(1)-(N) can facilitate communication between the untrusted app subnet(s) 862 contained in the data plane VCN 818 and the app subnet contained in the container egress VCN 868. The container egress VCN can include a NAT gateway 838 that can be communicatively coupled to public Internet 854 (e.g., public Internet 554 of FIG. 5).

The Internet gateway 834 contained in the control plane VCN 816 and contained in the data plane VCN 818 can be communicatively coupled to a metadata management service 852 (e.g., the metadata management system 552 of FIG. 5) that can be communicatively coupled to public Internet 854. Public Internet 854 can be communicatively coupled to the NAT gateway 838 contained in the control plane VCN 816 and contained in the data plane VCN 818. The service gateway 836 contained in the control plane VCN 816 and contained in the data plane VCN 818 can be communicatively coupled to cloud services 856.

In some examples, the pattern illustrated by the architecture of block diagram 800 of FIG. 8 may be considered an exception to the pattern illustrated by the architecture of block diagram 700 of FIG. 7 and may be desirable for a customer of the IaaS provider if the IaaS provider cannot directly communicate with the customer (e.g., a disconnected region). The respective containers 867(1)-(N) that are contained in the VMs 866(1)-(N) for each customer can be accessed in real-time by the customer. The containers 867(1)-(N) may be configured to make calls to respective secondary VNICs 872(1)-(N) contained in app subnet(s) 826 of the data plane app tier 846 that can be contained in the container egress VCN 868. The secondary VNICs 872(1)-(N) can transmit the calls to the NAT gateway 838 that may transmit the calls to public Internet 854. In this example, the containers 867(1)-(N) that can be accessed in real-time by the customer can be isolated from the control plane VCN 816 and can be isolated from other entities contained in the data plane VCN 818. The containers 867(1)-(N) may also be isolated from resources from other customers.

In other examples, the customer can use the containers 867(1)-(N) to call cloud services 856. In this example, the customer may run code in the containers 867(1)-(N) that requests a service from cloud services 856. The containers 867(1)-(N) can transmit this request to the secondary VNICs 872(1)-(N) that can transmit the request to the NAT gateway that can transmit the request to public Internet 854. Public Internet 854 can transmit the request to LB subnet(s) 822 contained in the control plane VCN 816 via the Internet gateway 834. In response to determining the request is valid, the LB subnet(s) can transmit the request to app subnet(s) 826 that can transmit the request to cloud services 856 via the service gateway 836.

It should be appreciated that IaaS architectures 500, 600, 700, 800 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

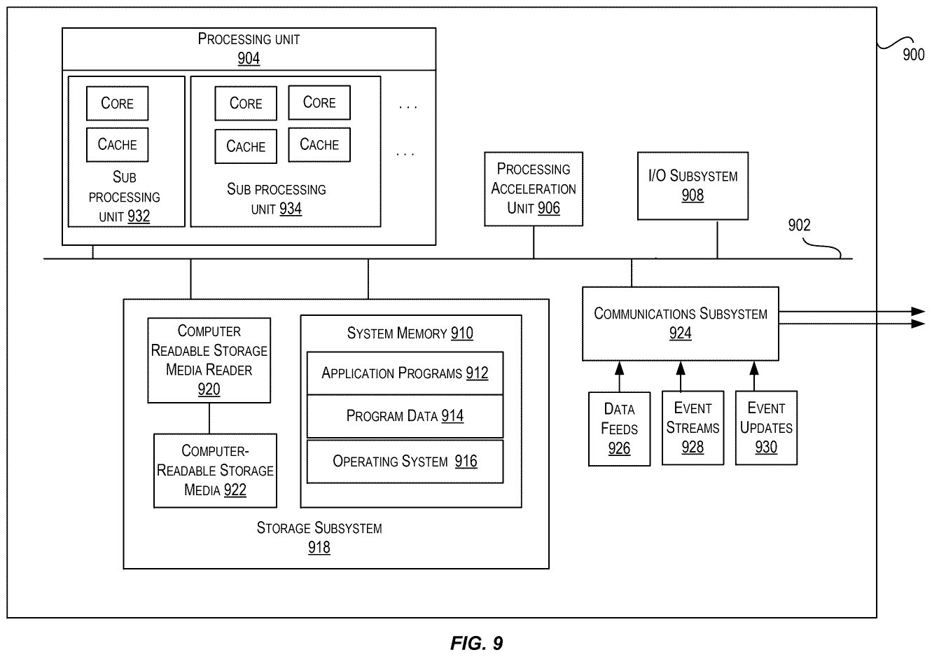

FIG. 9 illustrates an example computer system 900, in which various embodiments may be implemented. The system 900 may be used to implement any of the computer systems described above. As shown in the figure, computer system 900 includes a processing unit 904 that communicates with a number of peripheral subsystems via a bus subsystem 902. These peripheral subsystems may include a processing acceleration unit 906, an I/O subsystem 908, a storage subsystem 918 and a communications subsystem 924. Storage subsystem 918 includes tangible computer-readable storage media 922 and a system memory 910.

Bus subsystem 902 provides a mechanism for letting the various components and subsystems of computer system 900 communicate with each other as intended. Although bus subsystem 902 is shown schematically as a single bus, alternative embodiments of the bus subsystem may utilize multiple buses. Bus subsystem 902 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 904, which can be implemented as one or more integrated circuits (e.g., a conventional microprocessor or microcontroller), controls the operation of computer system 900. One or more processors may be included in processing unit 904. These processors may include single core or multicore processors. In certain embodiments, processing unit 904 may be implemented as one or more independent processing units 932 and/or 934 with single or multicore processors included in each processing unit. In other embodiments, processing unit 904 may also be implemented as a quad-core processing unit formed by integrating two dual-core processors into a single chip.

In various embodiments, processing unit 904 can execute a variety of programs in response to program code and can maintain multiple concurrently executing programs or processes. At any given time, some or all of the program code to be executed can be resident in processor(s) 904 and/or in storage subsystem 918. Through suitable programming, processor(s) 904 can provide various functionalities described above. Computer system 900 may additionally include a processing acceleration unit 906, which can include a digital signal processor (DSP), a special-purpose processor, and/or the like.

I/O subsystem 908 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 760 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 7D scanners, 7D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 900 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 900 may comprise a storage subsystem 918 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 904 provide the functionality described above. Storage subsystem 918 may also provide a repository for storing data used in accordance with the present disclosure.

As depicted in the example in FIG. 9, storage subsystem 918 can include various components including a system memory 910, computer-readable storage media 922, and a computer readable storage media reader 920. System memory 910 may store program instructions that are loadable and executable by processing unit 904. System memory 910 may also store data that is used during the execution of the instructions and/or data that is generated during the execution of the program instructions. Various different kinds of programs may be loaded into system memory 910 including but not limited to client applications, Web browsers, mid-tier applications, relational database management systems (RDBMS), virtual machines, containers, etc.

System memory 910 may also store an operating system 916. Examples of operating system 916 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android®OS, BlackBerry® OS, and Palm®OS operating systems. In certain implementations where computer system 900 executes one or more virtual machines, the virtual machines along with their guest operating systems (GOSs) may be loaded into system memory 910 and executed by one or more processors or cores of processing unit 904.

System memory 910 can come in different configurations depending upon the type of computer system 900. For example, system memory 910 may be volatile memory (such as random-access memory (RAM)) and/or non-volatile memory (such as read-only memory (ROM), flash memory, etc.) Different types of RAM configurations may be provided including a static random-access memory (SRAM), a dynamic random-access memory (DRAM), and others. In some implementations, system memory 910 may include a basic input/output system (BIOS) containing basic routines that help to transfer information between elements within computer system 900, such as during start-up.

Computer-readable storage media 922 may represent remote, local, fixed, and/or removable storage devices plus storage media for temporarily and/or more permanently containing, storing, computer-readable information for use by computer system 900 including instructions executable by processing unit 904 of computer system 900.

Computer-readable storage media 922 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 922 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 922 may include, but is not limited to, Zip® drives, flash memory cards, universal serial bus (USB) flash drives, secure digital (SD) cards, DVD disks, digital video tape, and the like. Computer-readable storage media 922 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 900.

Machine-readable instructions executable by one or more processors or cores of processing unit 904 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 924 provides an interface to other computer systems and networks. Communications subsystem 924 serves as an interface for receiving data from and transmitting data to other systems from computer system 900. For example, communications subsystem 924 may enable computer system 900 to connect to one or more devices via the Internet. In some embodiments communications subsystem 924 can include radio frequency (RF) transceiver components for accessing wireless voice and/or data networks (e.g., using cellular telephone technology, advanced data network technology, such as 7G, 8G, 9G or EDGE (enhanced data rates for global evolution), Wi-Fi (IEEE 802.11 family standards, or other mobile communication technologies, or any combination thereof)), global positioning system (GPS) receiver components, and/or other components. In some embodiments communications subsystem 924 can provide wired network connectivity (e.g., Ethernet) in addition to or instead of a wireless interface.

In some embodiments, communications subsystem 924 may also receive input communication in the form of structured and/or unstructured data feeds 926, event streams 928, event updates 930, and the like on behalf of one or more users who may use computer system 900.

By way of example, communications subsystem 924 may be configured to receive data feeds 926 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 924 may also be configured to receive data in the form of continuous data streams, which may include event streams 928 of real-time events and/or event updates 930, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 924 may also be configured to output the structured and/or unstructured data feeds 926, event streams 928, event updates 930, and the like to one or more databases that may be in communication with one or more streaming data source computers coupled to computer system 900.

Computer system 900 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 900 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed:

1. A system to facilitate contextualized alt text generation for web images, the system comprising:
one or more processing devices; and
memory communicatively coupled with and readable by the one or more processing devices and having stored therein processor-readable instructions which, when executed by the one or more processing devices, cause the system to perform operations comprising:
parsing a webpage to extract one or more images and text from the webpage, wherein the webpage is rendered with an endpoint device;
analyzing the one or more images from the webpage to detect one or more representations of one or more persons in the one or more images;
performing face localization to detect one or more faces in the one or more representations of the one or more persons;
generating a face embedding for each detected face of the detected one or more faces to create a set of one or more face embeddings;
analyzing the text extracted from the webpage to detect one or more named entities in the text;
generating a name embedding for each detected named entity of the detected one or more named entities to create a set of one or more name embeddings;
using bipartite matching to correlate at least part of the set of one or more face embeddings with at least part of the set of one or more name embeddings to create a set of correlation results;
causing generation of contextualized alt text based at least in part on the set of correlation results from the bipartite matching; and
transmitting the contextualized alt text to the endpoint device to facilitate audible presentation of the contextualized alt text with assistive technology software.

2. The system to facilitate contextualized alt text generation for web images as recited in claim 1, wherein a web browser plugin or web extension of a browser of the endpoint device facilitates the parsing of the webpage to extract the one or more images and the text from the webpage.

3. The system to facilitate contextualized alt text generation for web images as recited in claim 1, the operations further comprising:
analyzing the text extracted from the webpage to recognize context; and
generating, based at least in part on the analyzing, a context description for the webpage;
wherein the generation of the contextualized alt text is based at least in part on the context description.

4. The system to facilitate contextualized alt text generation for web images as recited in claim 1, the operations further comprising:
analyzing the one or more images from the webpage to recognize one or more facial expressions in the one or more faces in the one or more representations of the one or more persons;
wherein the generation of the contextualized alt text is based at least in part on the recognized one or more facial expressions.

5. The system to facilitate contextualized alt text generation for web images as recited in claim 1, the operations further comprising:
analyzing the one or more images from the webpage to recognize one or more actions and/or one or more objects represented in the one or more images;
wherein the generation of the contextualized alt text is based at least in part on the recognized one or more actions and/or the recognized one or more objects.

6. The system to facilitate contextualized alt text generation for web images as recited in claim 1, wherein the bipartite matching uses face embeddings and name embeddings previously stored in cloud data storage to correlate the at least part of the set of one or more face embeddings with the at least part of the set of one or more name embeddings to create a set of correlation results.

7. The system to facilitate contextualized alt text generation for web images as recited in claim 6, wherein the cloud data storage is private and personalized to a user of the endpoint device based at least in part on a browsing history of the user.

8. The system to facilitate contextualized alt text generation for web images as recited in claim 6, the operations further comprising:
using the contextualized alt text to re-rank the face embeddings and the name embeddings previously stored in the cloud data storage based at least in part on updating one or more weight values of one or more bipartite edge weights between the face embeddings and the name embeddings.

9. A method for contextualized alt text generation for web images, the method comprising:
parsing a webpage to extract one or more images and text from the webpage, wherein the webpage is rendered with an endpoint device;
analyzing the one or more images from the webpage to detect one or more representations of one or more persons in the one or more images;
performing face localization to detect one or more faces in the one or more representations of the one or more persons;
generating a face embedding for each detected face of the detected one or more faces to create a set of one or more face embeddings;
analyzing the text extracted from the webpage to detect one or more named entities in the text;
generating a name embedding for each detected named entity of the detected one or more named entities to create a set of one or more name embeddings;
using bipartite matching to correlate at least part of the set of one or more face embeddings with at least part of the set of one or more name embeddings to create a set of correlation results;
causing generation of contextualized alt text based at least in part on the set of correlation results from the bipartite matching; and
transmitting the contextualized alt text to the endpoint device to facilitate audible presentation of the contextualized alt text with assistive technology software.

10. The method for contextualized alt text generation for web images as recited in claim 9, wherein a web browser plugin or web extension of a browser of the endpoint device facilitates the parsing of the webpage to extract the one or more images and the text from the webpage.

11. The method for contextualized alt text generation for web images as recited in claim 9, further comprising:
analyzing the text extracted from the webpage to recognize context; and
generating, based at least in part on the analyzing, a context description for the webpage;
wherein the generation of the contextualized alt text is based at least in part on the context description.

12. The method for contextualized alt text generation for web images as recited in claim 9, further comprising:
analyzing the one or more images from the webpage to recognize one or more facial expressions in the one or more faces in the one or more representations of the one or more persons;
wherein the generation of the contextualized alt text is based at least in part on the recognized one or more facial expressions.

13. The method for contextualized alt text generation for web images as recited in claim 9, further comprising:
analyzing the one or more images from the webpage to recognize one or more actions and/or one or more objects represented in the one or more images;
wherein the generation of the contextualized alt text is based at least in part on the recognized one or more actions and/or the recognized one or more objects.

14. The method for contextualized alt text generation for web images as recited in claim 9, wherein the bipartite matching uses face embeddings and name embeddings previously stored in cloud data storage to correlate the at least part of the set of one or more face embeddings with the at least part of the set of one or more name embeddings to create a set of correlation results.

15. The method for contextualized alt text generation for web images as recited in claim 14, wherein the cloud data storage is private and personalized to a user of the endpoint device based at least in part on a browsing history of the user.

16. The method for contextualized alt text generation for web images as recited in claim 14, further comprising:
using the contextualized alt text to re-rank the face embeddings and the name embeddings previously stored in the cloud data storage based at least in part on updating one or more weight values of one or more bipartite edge weights between the face embeddings and the name embeddings.

17. One or more non-transitory, machine-readable media having machine-readable instructions thereon which, when executed by one or more processing devices, cause the one or more processing devices to perform operations comprising:
parsing a webpage to extract one or more images and text from the webpage, wherein the webpage is rendered with an endpoint device;
analyzing the one or more images from the webpage to detect one or more representations of one or more persons in the one or more images;
performing face localization to detect one or more faces in the one or more representations of the one or more persons;
generating a face embedding for each detected face of the detected one or more faces to create a set of one or more face embeddings;
analyzing the text extracted from the webpage to detect one or more named entities in the text;
generating a name embedding for each detected named entity of the detected one or more named entities to create a set of one or more name embeddings;
using bipartite matching to correlate at least part of the set of one or more face embeddings with at least part of the set of one or more name embeddings to create a set of correlation results;
causing generation of contextualized alt text based at least in part on the set of correlation results from the bipartite matching; and
transmitting the contextualized alt text to the endpoint device to facilitate audible presentation of the contextualized alt text with assistive technology software.

18. The one or more non-transitory, machine-readable media as recited in claim 17, wherein a web browser plugin or web extension of a browser of the endpoint device facilitates the parsing of the webpage to extract the one or more images and the text from the webpage.

19. The one or more non-transitory, machine-readable media as recited in claim 17, the operations further comprising:
analyzing the text extracted from the webpage to recognize context; and
generating, based at least in part on the analyzing, a context description for the webpage;
wherein the generation of the contextualized alt text is based at least in part on the context description.

20. The one or more non-transitory, machine-readable media as recited in claim 17, the operations further comprising:
analyzing the one or more images from the webpage to recognize one or more facial expressions in the one or more faces in the one or more representations of the one or more persons;
wherein the generation of the contextualized alt text is based at least in part on the recognized one or more facial expressions.
